(19) United States
(12) Patent Application Publication
(10) Pub. No.: US 2008/0136187 A1
(43) Pub. Date: Jun. 12, 2008

(54) WIND-POWERED ELECTRICITY GENERATOR

(76) Inventors: Ching-Hai Liao, Taichung (TW); Xi-Hai Liu, Kunshan City (CN)

Correspondence Address: Hershkovitz & Associates, LLC, 2845 Duke Street, Alexandria, VA, 22314, US

(21) Appl. No.: 11/598,737

(22) Filed: Nov. 14, 2006

(51) Int. Cl. H02P 9/00; F03D 9/00; F03D 9/02

(52) U.S. Cl. 290/44; 290/55

(57) ABSTRACT

A wind-powered electricity generator includes a base, an axle, a case, a blade assembly and a power supply device. The axle is mounted on the base and has a post and stator. The stator is mounted around the post and has multiple winding sets. The winding set is mounted in the stator, arranged in a circle around the post and each winding set includes sequentially a primary winding, a secondary winding and an excited winding. The case is mounted rotatably around the stator upon the base, is hollow and has an inner surface and a rotor. The rotor is attached to the inner surface of the case, corresponds to the stator and has multiple magnets. The magnets are mounted in the rotor and arranged in a circle around the stator. The blade assembly is mounted on the outer surface of the case. The power supply device is connected to the wires of the windings.

### BACKGROUND OF THE INVENTION

1. Field of Invention

The present invention relates to a wind-powered electricity generator, and more particularly to a wind-powered electricity generator that can generate electricity in a breeze.

2. Description of the Related Art

Because industry advances rapidly, reserves of petroleum and coal deplete gradually and economic cost of petroleum and coal also increases. Relationship between different countries may become nervous because of bidding for energy. Therefore, technology of using renewable energy such as water, wind and solar power becomes more and more important.

Conventional wind-powered electricity generators usually work when wind speed is greater than a breeze. If wind speed is slower than a breeze, the conventional wind-powered electricity generators cannot work because that rotation of turbines and gears of the conventional wind-powered electricity generator needs power for overcoming friction and to start the rotation. So, developing a wind-powered electricity generator that can generate electricity in a breeze is necessary.

To overcome the shortcomings, the present invention provides a wind-powered electricity generator to mitigate or obviate the aforementioned problems.

### SUMMARY OF THE INVENTION

The primary objective of the present invention is to provide a wind-powered electricity generator that can generate electricity in a breeze and rotational speed of the blades of the generator can be slowed down in a strong wind.

The wind-powered electricity generator comprises a base, an axle, a case, a blade assembly and a power supply device. The axle is mounted on the base and has a post and stator. The post is mounted on the base. The stator is mounted around the post and has multiple winding sets. The winding sets are mounted in the stator, arranged in a circle around the post and each winding set comprises, sequentially, a primary winding, a secondary winding and an excited winding. Each winding has a wire extended through and protruding from the post.

The case is mounted rotatably around the stator upon the base, is hollow and has a top, a bottom, an inner surface, an outer surface and a rotor. The top is mounted rotatably around the post. The bottom is mounted rotatably around the post. The rotor is attached to the inner surface of the case, corresponds to the stator and has multiple magnets. The magnets are mounted in the rotor, are arranged in a circle around the stator and each magnet has a north pole and a south pole. The north poles and south poles of adjacent magnets are arranged in an alternative manner.

The blade assembly is mounted on the outer surface of the case.

The power supply device is connected to the wires of the windings.

When the generator is started in a breeze, the power supply device provides electrical power to the primary windings and the secondary windings to rotate the rotor.

When the rotational speed of the rotor is lower than a predetermined lower level in a breeze, the power supply device provides electrical power to the secondary windings to produce a complementary torque on the rotor to increase the rotational speed of the rotor.

When the rotational speed of the rotor is higher than a predetermined upper level, the power supply device provides electrical power to the excited windings to produce a stall-torque on the rotor to reduce the rotational speed of the rotor.

Other objectives, advantages and novel features of the invention will become more apparent from the following detailed description when taken in conjunction with the accompanying drawings.

### BRIEF DESCRIPTION OF THE DRAWINGS

FIG. 1 is a planar diagram of a wind-powered electricity generator in accordance with the present invention;

FIG. 2 is a side view in partial section of the generator in FIG. 1;

FIG. 3 is a cross-sectional view of the rotor and the stator of the generator in FIG. 1;

FIG. 4 is an enlarged cross-sectional view of the rotor of the generator in FIG. 1; and

FIG. 5 is an enlarged cross-sectional view of the stator of the generator in FIG. 1.

### DETAILED DESCRIPTION OF THE INVENTION

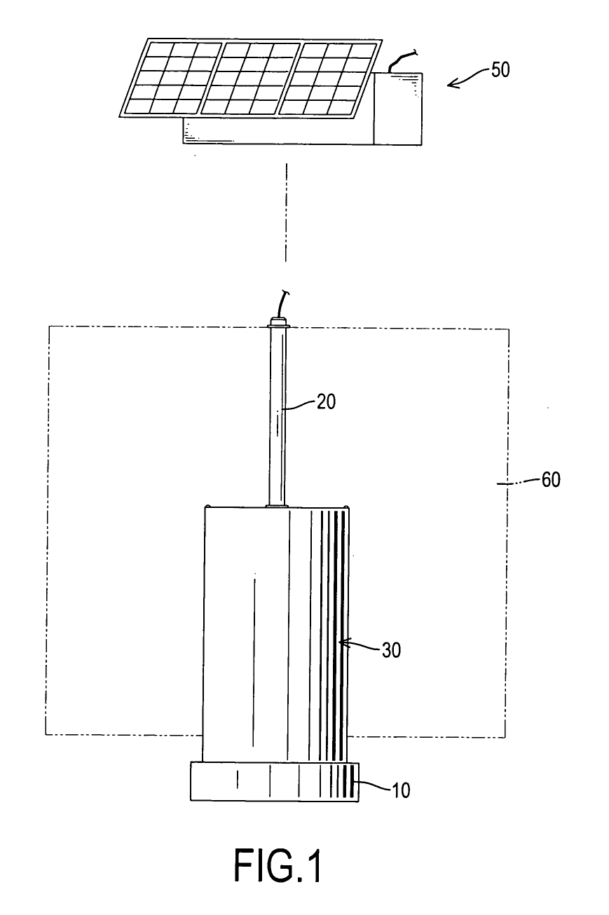

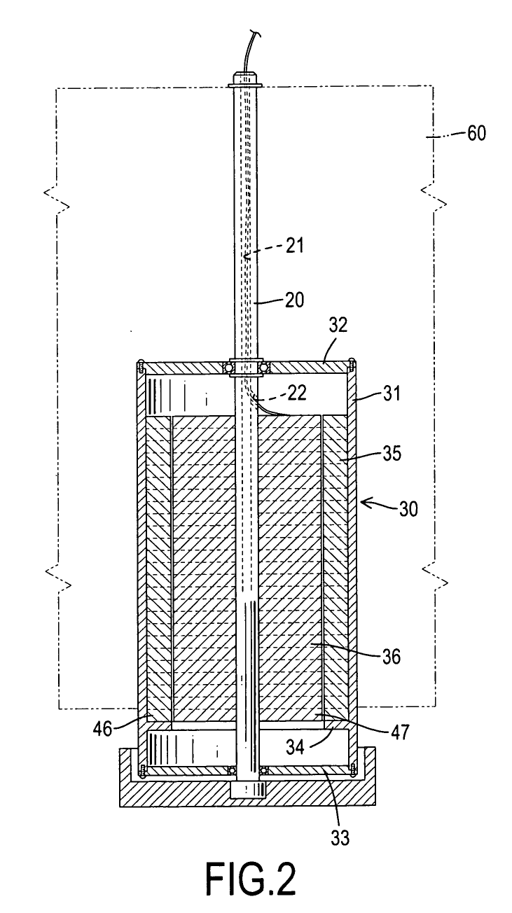

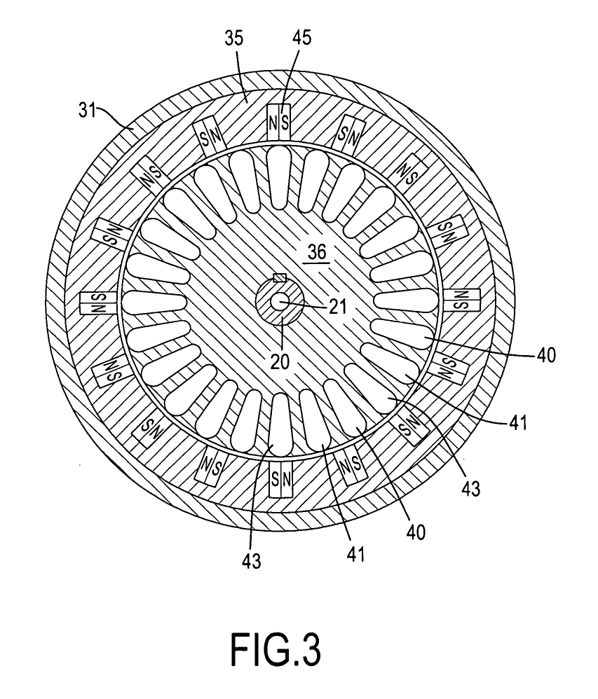

With reference to FIGS. 1, 2 and 3, a wind-powered electricity generator in accordance with the present invention comprises a base (10), an axle, a case (30), a blade assembly (60) and a power supply device (50).

The base (10) is mounted on a fixed object such as the ground.

The axle is mounted on the base (10) and has a post (20) and a stator (36). The post (20) is mounted on the base (10), is extended vertically relative to the ground and has a top, an outer surface, a connecting hole (21) and a wire hole (22). The connecting hole (21) is defined in the top of the post (20). The wire hole (22) is defined in the outer surface of the post (20) and communicates with the connecting hole (21).

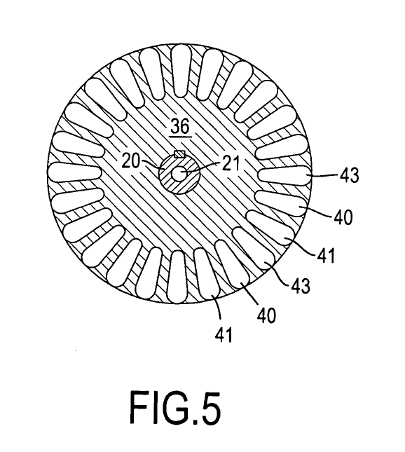

With further reference to FIG. 5, the stator (36) is mounted around the post (20), is cylindrical and has a center, a through hole, an inner surface and multiple winding sets, and may be composed of a stack of silicon steel sheets (47). Thickness of the silicon steel sheets (47) is 0.35 mm. The through hole is defined axially through the center of the stator (36) and is mounted around and engaged with the post (20) with a key and keyways.

The winding sets are mounted in the stator (36), are arranged in a circle around the post (20) and are numbered from 8 to 12. Each wind set comprises sequentially a primary winding (40), a secondary winding (41) and an excited winding (43). Each winding (40, 41, 43) has a wire extended through the wire hole (22) and the connecting hole (21) of the post (20) and protruding from the top of the post (20).

The case (30) is mounted rotatably around the stator (36) upon the base (10) and has a tubular body (31), a top board (32), a bottom board (33) and a rotor (35). The tubular body (31) has a top, a bottom, an inner surface, an outer surface and a flange (34). The flange (34) is formed on the inner surface of the tubular body (31) near the bottom and is extended radically. The top board (32) is attached to the top of the tubular body (31) and is mounted rotatably around the post (20). The bottom board (33) is attached to the bottom of the tubular body (31) and is mounted rotatably around the post (20). Accordingly, the case (30) can pivot freely relative to the post (20).

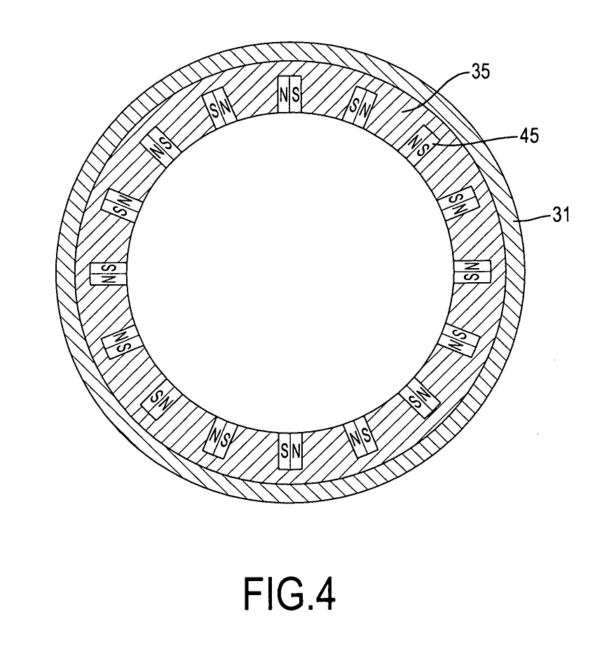

With further reference to FIG. 4, the rotor (35) is attached to the inner surface of the tubular body (31) upon the flange (34), corresponds to the stator (36) and has multiple Nd—Fe—B magnets (45) and may be composed of a stack of silicon steel sheets (46). Thickness of the silicon steel sheets (46) is 0.35 mm. The Nd—Fe—B magnets (45) are mounted in the rotor (35) to produce a magnetic field, are arranged in a circle around the stator (36) and are numbered from 8 to 16. Each Nd—Fe—B magnet (45) has a north pole (N) and a south pole (S). The north poles and south poles of adjacent Nd—Fe—B magnets (45) are arranged in an alternative manner. Number of the magnetic poles of the rotor (35) determines wiring of the primary windings (41) and secondary windings (42). The rotational speed of the rotor (35) controls direction and magnitude of current in each excited winding (43).

The blade assembly (60) is mounted on the outer surface of the tubular body (31) and is suitable for the wind-powered electricity generator.

The power supply device is connected to the wires of the windings and may be a solar energy device (50) or an accumulator for providing electrical power to the windings (40, 41, 43) through the wires. The power supply is control by program in a computer. The interface of the computer uses a transistor switch circuit to control working conditions of the primary windings (40), the secondary windings (41) and the excited windings (43).

When the wind speed is lower than a predetermined lower level and the generator is at a stationary condition, the power supply device is programmed to provide electrical power to the primary windings (40) and the secondary windings (41) to rotate the rotor (35). After the rotor (35) is rotated and the wind generator is started, the primary windings (40) will become windings for generating electricity. If the rotational speed of the rotor (35) is too slow in a breeze, the power supply device will provide electrical power to the secondary windings (41) to produce a complementary torque on the rotor (35) to increase the rotational speed of the rotor (35) and to keep the wind generator working.

When the rotational speed of the rotor (35) is higher than a predetermined upper level, the power supply device will provide electrical power to the excited windings (43). So the excited windings (43) are excited to produce a magnetic field that is inversed to the magnetic field produced by the rotor (35) and a stall-torque is applied to the rotor (35) to reduce the rotational speed of the rotor (35). Accordingly, the wind-powered electricity generator applies brakes in a soft way to prevent the generator from burning down.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A wind-powered electricity generator comprising
a base;
an axle being mounted on the base and having
a post being mounted on the base; and
a stator being mounted around the post and having
multiple winding sets being mounted in the stator, arranged in a circle around the post and each winding set comprising sequentially a primary winding, a secondary winding and an excited winding, wherein each winding has a wire extended through and protruding from the post;
a case being mounted rotatably around the stator upon the base, being hollow and having
a top being mounted rotatably around the post;
a bottom being mounted rotatably around the post;
an inner surface;
an outer surface; and
a rotor being attached to the inner surface of the case, corresponding to the stator and having
multiple magnets being mounted in the rotor and arranged in a circle around the stator and each magnet having a north pole and a south pole, wherein the north poles and the south poles of adjacent magnets are arranged in an alternative manner;
a blade assembly being mounted on the outer surface of the case; and
a power supply device being connected to the wires of the windings, wherein
when the generator is started in a breeze, the power supply device provides electrical power to the primary windings and the secondary windings to rotate the rotor;
when the rotational speed of the rotor is lower than a predetermined lower level, the power supply device provides electrical power to the secondary windings to produce a complementary torque on the rotor to increase the rotational speed of the rotor; and
when the rotational speed of the rotor is higher than a predetermined upper level, the power supply device provides electrical power to the excited windings to produce a stall-torque on the rotor to reduce the rotational speed of the rotor.

2. The wind-powered electricity generator as claimed in claim 1, wherein the power supply device is a solar energy device.

3. The wind-powered electricity generator as claimed in claim 2, wherein
the case further has a flange formed on the inner surface of the case near the bottom and extended radically; and
the rotator is mounted upon the flange.

4. The wind-powered electricity generator as claimed in claim 3, wherein the case further comprises
a tubular body having
a top; and
a bottom;
a top board being attached to the top of the tubular body and mounted rotatably around the post; and
a bottom board being attached to the bottom of the tubular body and mounted rotatably around the post.

5. The wind-powered electricity generator as claimed in claim 4, wherein the post of the axle further comprises
a connecting hole being defined in the post; and
a wire hole being defined in the post and communicating with the connecting hole.

6. The wind-powered electricity generator as claimed in claim 5, wherein the power supply device is an accumulator.

7. The wind-powered electricity generator as claimed in claim 6, wherein
the case further has a flange formed on the inner surface of the case near the bottom and extended radically; and
the rotator is mounted upon the flange.

8. The wind-powered electricity generator as claimed in claim 7, wherein the case further comprises
a tubular body having
a top; and
a bottom;
a top board being attached to the top of the tubular body and mounted rotatably around the post; and
a bottom board being attached to the bottom of the tubular body and mounted rotatably around the post.

9. The wind-powered electricity generator as claimed in claim 8, wherein the post of the axle further comprises
a connecting hole being defined in the post; and
a wire hole being defined in the post and communicating with the connecting hole.

10. The wind-powered electricity generator as claimed in claim 1, wherein the post of the axle further comprises
a connecting hole being defined in the post; and
a wire hole being defined in the post and communicating with the connecting hole.

11. The wind-powered electricity generator as claimed in claim 2, wherein the post of the axle further comprises
a connecting hole being defined in the post; and
a wire hole being defined in the post and communicating with the connecting hole.

12. The wind-powered electricity generator as claimed in claim 3, wherein the post of the axle further comprises
a connecting hole being defined in the post; and
a wire hole being defined in the post and communicating with the connecting hole.

13. The wind-powered electricity generator as claimed in claim 1, wherein
the rotor is composed of a stack of silicon steel sheets and the magnets are mounted in the sake of silicon steel sheets; and
the stator is composed of a stack of silicon steel sheets.

14. The wind-powered electricity generator as claimed in claim 2, wherein
the rotor is composed of a stack of silicon steel sheets and the magnets are mounted in the sake of silicon steel sheets; and
the stator is composed of a stack of silicon steel sheets.

15. The wind-powered electricity generator as claimed in claim 3, wherein
the rotor is composed of a stack of silicon steel sheets and the magnets are mounted in the sake of silicon steel sheets; and
the stator is composed of a stack of silicon steel sheets.

16. The wind-powered electricity generator as claimed in claim 13, wherein thickness of the silicon steel sheets is 0.35 mm.

17. The wind-powered electricity generator as claimed in claim 14, wherein thickness of the silicon steel sheets is 0.35 mm.

18. The wind-powered electricity generator as claimed in claim 15, wherein thickness of the silicon steel sheets is 0.35 mm.
